(19) United States
(12) Patent Application Publication
(10) Pub. No.: US 2004/0180246 A1
(43) Pub. Date: Sep. 16, 2004

(54) Self-contained fuel cell

(76) Inventor: Stuart I. Smedley, Escondido, CA (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 10/385,147

(22) Filed: Mar. 10, 2003

(51) Int. Cl. H01M 8/04; H01M 8/18

(52) U.S. Cl. 429/19; 429/17; 429/27

(57) ABSTRACT

Improved self-contained fuel cells have a gas diffusion electrode suitable for reducing molecular oxygen and a separate gas diffusion electrode suitable for generating molecular oxygen. The fuel for the cell generally is in contact with both gas diffusion electrodes such that the fuel can be regenerated within the cell. In some embodiments, the fuel and the oxidation products of the fuel are in the form of a flowable paste that can be circulated within the cell to maintain a more uniform concentration of fuel within the cell.

### FIELD OF THE INVENTION

The invention relates to fuel cell power sources, and in particular to fuel cells that are self -contained with respect to cell discharge and fuel regeneration.

### BACKGROUND OF THE INVENTION

Fuel cells, as with batteries, generate useful energy by providing an oxidation reaction at a negative electrode and a reduction reaction at a positive electrode. The electrical potential difference between the positive electrode and the negative electrode can be used to generate useful energy. A fuel cell differs from a battery in that the reactants for maintaining the reduction-oxidation reactions can be supplied without disassembling the fuel cell. In secondary batteries, an external potential can be applied to the cell to reverse the reduction/oxidation reactions to drive the reactions in the reverse direction thereby regenerating the reactants. However, in secondary batteries, both reactants do not flow through the system, although the necessary ions diffuse through the structure to maintain electrical neutrality and to provide appropriate elements for the reactions at the electrodes. Even in batteries in which one reactant is a gas, the other reactant generally does not flow. In contrast, in a fuel cell both reactants generally flow within the system to provide the appropriate reactants at the specific electrode. In other words, the fuel can be replenished to continue energy generation.

Fuel cells can often involve one or more gaseous reactants. Gas diffusion electrodes, i.e., gas permeable electrodes, are suitable for use in electrochemical cells that have gaseous reactants, for example, for use in the cathode for the reduction of oxygen, bromine or hydrogen peroxide. The reduction of gaseous molecular oxygen can be an electrode reaction, for example, in metal-air/oxygen batteries, metal-air/oxygen fuel cells and hydrogen-oxygen fuel cells. Oxygen is generally conveniently supplied to these electrochemical cells in the form of air. Similarly, the oxidation of gaseous molecular hydrogen can be the anode reaction in hydrogen-oxygen fuel cells.

The cathode in an electrochemical cell containing an alkaline electrolyte and involving oxygen reduction generally catalyzes the reduction of oxygen, which combines with water to form hydroxide ions. The reduction of oxygen removes electrons at the cathode. The oxidation reaction at the anode gives rise to the electrons that flow to the cathode when the circuit connecting the anode and the cathode is closed. The electrons flowing through the closed circuit enable the foregoing oxygen reduction reaction at the cathode and simultaneously can enable the performance of useful work due to an over- voltage between the cathode and anode. For example, in one embodiment of a fuel cell employing metal, such as zinc, iron, lithium and/or aluminum, as a fuel and potassium hydroxide as an electrolyte, the oxidation of the metal to form an oxide or a hydroxide releases electrons. In some systems, a plurality of cells is coupled in series, which may or may not be within a single fuel cell unit, to provide a desired voltage. For commercially viable fuel cells, it is desirable to have electrodes that can function within desirable parameters for extended period of time on the order of 1000 hours or even more.

### SUMMARY OF THE INVENTION

In a first aspect, the invention pertains to a fuel cell comprising a pump, a first chamber, an electrode suitable for reduction of molecular oxygen accessible to the first chamber and an electrode suitable for evolution of molecular oxygen. In this embodiment, the pump can be configured to circulate flow of a fuel cell composition comprising a fuel within the chamber. In some embodiments, the fuel cell comprises a first chamber and a second chamber, and the pump circulates a fuel cell composition between the first chamber and the second chamber. The fuel cell composition can be selectively coupled as a cell with the electrode suitable for reduction of molecular oxygen and the electrode suitable for evolution of molecular oxygen.

In a further aspect, the invention pertains to a fuel cell comprising a first gas diffusion electrode suitable for reduction of molecular oxygen, a second gas diffusion electrode suitable for evolution of molecular oxygen. In this embodiment, a negative electrode is provided comprising a fuel, where a first separator is located between the first gas diffusion electrode and the negative electrode and where a second separator is between the second gas diffusion electrode and the negative electrode. The first electrode comprises a suitable catalyst, and the second electrode comprises a suitable catalyst and can be substantially free of amorphous carbon.

In another aspect, a self contained fuel cell and fuel regeneration system comprises a first gas diffusion electrode suitable for reduction of molecular oxygen, a second gas diffusion electrodes suitable for evolution of molecular oxygen and a negative electrode comprising a fuel. In this embodiment, a first separator is between the first gas diffusion electrode and the positive electrode, and a second separator is between the second gas diffusion electrode and the positive electrode. The self contained system has a volume less than about 1 liter.

Moreover, the invention pertains to a portable power generation system comprising a negative electrode, a positive electrode, an electroactive fuel, electrolyte, and a pump. In this embodiment, the pump comprises an expansion chamber within a pump chamber and the pump is configured to circulate the electrolyte. The pump chamber comprises a first check value that permits flow into the pump chamber and a second check value that permits flow out from the pump chamber.

In addition, the invention pertains to a method for generating power with a portable self-contained power source comprising a first chamber and a second chamber. The method comprises discharging the power source to convert a fuel into a reaction product in a first chamber, wherein the reaction product is deposited in a flowable electrolyte, circulating the electrolyte between the first chamber and the second chamber and regenerating the fuel in the second chamber.

In another method according to the present invention, a method of generating power with a portable self-contained power source comprises discharging the power source and regenerating the power source. The fuel cell comprises a first gas diffusion electrode suitable for reduction of molecular oxygen, a second gas diffusion electrode suitable for evolution of molecular oxygen and a central electrode between the first gas diffusion electrode and the second gas diffusion electrode. In this embodiment, discharging the power source can be performed through an electrical contact connected to the first gas diffusion electrode and an electrical contact connected to the central electrode. In addition, regenerating the power source can be performed through applying an external potential to an electrical contact connected to the second gas diffusion electrode and an electrical contact connected to the central electrode.

### BRIEF DESCRIPTION OF THE DRAWINGS

FIG. 1 is a cross sectional view of one embodiment of the present invention.

FIG. 2 is a cross sectional view of a fuel cell comprising a first chamber and a second chamber.

FIG. 3 is a schematic sectional view of an embodiment of an electrochemically based pump for fluids.

FIG. 4 is a schematic sectional view of an embodiment of an expansion chamber.

FIG. 5 is a schematic sectional view of an alternate embodiment expansion chamber.

FIG. 6 is a schematic sectional view of an alternate embodiment of an expansion chamber.

FIG. 7 is a cross section view of an alternate embodiment of the present invention.

### DETAILED DESCRIPTION OF THE INVENTION

Self-contained fuel cells described herein comprise separate gas diffusion electrodes for the reduction of molecular oxygen and the evolution of molecular oxygen. By using different electrodes for the separate oxidation and reduction reactions involving molecular oxygen, the composition of the electrodes can be selected to be appropriate for the particular reactions to obtain stable long-term performance. In particular, the gas diffusion electrode for the reduction of oxygen can be selected for long-term operation in alkaline electrolytes while generating OH⁻ following the reduction of molecular oxygen. For example, pores of the active layer can be filled with an ion-conducting polymer. Also, the gas diffusion electrode for the evolution of molecular oxygen by the oxidation of water can be selected for long-term operation at high potentials and high current without degrading significantly. For example, the electrode can be free from reactive carbon, such as amorphous carbon. The self-contained fuel cells described herein are a suitable replacement for rechargeable batteries.

In some embodiments, the self-contained fuel cells can comprise a metal fuel, such as elemental zinc and/or a zinc alloy. While in some embodiments, a stationary positive electrode (which is a cathode during cell discharge) is used, in alternative or additional embodiments, the fuel of the negative electrode is in a flowable composition that is circulated between a positive electrode (which is a cathode during cell discharge) selected for reduction of molecular oxygen and a positive electrode (which is an anode during fuel regeneration) selected for generation of molecular oxygen. In some embodiments, the negative electrode composition is circulated within a chamber in contact with both the positive electrode selected for the reduction of molecular oxygen and the positive electrode selected for the generation of molecular oxygen. In some embodiments, the negative electrode composition is circulated between a chamber in contact with the positive electrode suitable for the reduction of molecular oxygen and another chamber in contact with the positive electrode suitable for the evolution of molecular oxygen. As clarified below, even in embodiments in which the fuel is not flowing, it is referred to as a fuel cell since a separate electrode is used for cell discharge and fuel regeneration. A suitable compact pump can be used to circulate the flowable composition with the fuel and reduced fuel product. The term pump is used in its broad sense of any device that moves or compresses fluids.

Fuel cells, in general, differ from batteries in that fuel cells can be supplied with additional fuel to maintain operation of the fuel cell. Batteries generally have a fixed amount of electroactive materials that are consumed when the battery is discharged. With primary batteries, the battery is discarded when the battery voltage falls below an acceptable level. Secondary batteries can be recharged by applying an external potential to reverse the reduction-oxidation reaction to regenerate the electro-active materials. For some fuel cells, it is desirable to regenerate the fuel if the materials in the fuel are expensive or if it is not easy to supply additional fuel from a reservoir, for example, for space applications. In these embodiments, the oxidized form of the fuel is removed from the fuel cell, generally with electrolyte, and directed either to a storage tank for later regeneration or directly to a regeneration unit. These fuel cells still differ from a secondary battery since the fuel is removed and regenerated in a separate unit.

The self-contained fuel cells described herein differ from these other fuel cells in that the cell discharge and fuel regeneration are performed in close proximity, generally within a common container. In some embodiments, a common negative electrode is used for both cell discharge and fuel regeneration. However, these fuel cells still differ from secondary batteries in that separate positive electrodes are used for cell discharge and for fuel regeneration. Thus, the regenerative positive electrode provides, upon fuel regeneration, a source of fuel for anodic dissolution at the negative electrode during cell discharge. For convenience these embodiments are consistently referred to as fuel cells whether or not the fuel actually flows within the self-contained system. In some embodiments, the self-contained fuel cell can be portable in the sense that they can be carried during operation by an average person without mechanical assistance.

The fuel cell comprises at least one positive electrode suitable for reduction of molecular oxygen, at least one positive electrode suitable for evolution of molecular oxygen from the splitting of water and at least one negative electrode, at which fuel is consumed during cell discharge and is regenerated during recharging. An electrolyte generally provides for maintenance of electrical neutrality during discharge and recharge. In some embodiments with a basic aqueous electrolyte, i.e., with OH⁻ ions, the reactions at the negative electrodes can be represented by the following reaction: The two released electrons flow through a load to the cathode where the following reaction takes place:

$$\frac{1}{2} {O}_{2} + 2 {e}^{-} + {H}_{2} O \to 2 {OH}^{-} \qquad ( 1 )$$

with the forward reaction taking place at the positive electrode suitable for reduction of molecular oxygen and the reverse reaction taking place at the electrode suitable for evolution of molecular oxygen. The gas permeable electrodes provide for the movement of molecular oxygen to or away from the electrode. In some embodiments, the gas permeable electrodes can be in contact with the air at the exterior of the fuel cell to provide for transfer of gas, in particular oxygen (O₂) through a hydrophobic material to the active layer of the electrode.

While a variety of fuels can be used to participate in the reactions at the negative electrode, metals, such as elemental metals, provide a high density so that the volume of the fuel cell can be smaller for a given capacity to deliver power. In particular, zinc can be used as a fuel. With zinc as a fuel, the reaction at the cathode can be represented by the following reaction:

Zn+4OH⁻→Zn(OH)₄²⁻+2e⁻ (2)

During discharge of the fuel cell, the forward reaction takes place, and during recharging of the fuel cell, the reverse reaction takes place. Alternatively, the zincate ion, Zn(OH)₄²⁻, can be allowed to precipitate to zinc oxide, ZnO, a second reaction product, in accordance with the following reaction:

Zn(OH)₄²⁻→ZnO+H₂O+2OH⁻ (3)

In this case, the overall reaction which occurs in the cell cavities is the combination of the three reactions (1), (2), and (4). This overall reaction can be expressed as follows:

$$Zn + \frac{1}{2} {O}_{2} \to Zn O \qquad ( 4 )$$

The electroactive material associated with the negative electrode, e.g., the Zn and ZnO, generally is coupled through the electrolyte to both negative electrodes. While achieving acceptable electrical impedance in the fuel cell, this can be accomplished by physically locating the positive electrode in contact with the negative electrodes through appropriate separators. However, a stationary negative electrode results in fronts corresponding to composition changes that propagate from each of the respective negative electrodes. Specifically, the fuel is consumed in the negative electrode along a front moving away from the positive electrode that reduces molecular oxygen. However, the fuel is regenerated along a front that moves away from the positive electrode that evolves molecular oxygen. Alternatively or additionally, the electroactive material of the negative electrode can be in the form of a flowable material, such as a paste. The flowable material can be circulated such that the oxidized and reduced forms of the fuel can be circulated to different portions of the fuel cell to achieve more even performance of the fuel cell during the discharge and recharging cycles.

In some embodiments, the fuel of the negative electrode is circulated within a single chamber in contact through a separator with a positive electrode selected for the reduction of molecular oxygen and a positive electrode selected for the generation of molecular oxygen. However, generally the chamber is divided by one or more current collectors for the negative electrode that complicate the flow within the chamber. In alternative or additional embodiments, the fuel cell is divided into different chambers with the flowable negative electrode material circulated between the chambers. A well defined flow pattern can be established through the use of two chambers. The chambers can be connected with one or more common current collectors that provide electrical conductivity between the negative electrode materials within the adjacent chambers, although one or more separate current collectors can be used for the separate chambers. In some embodiments, chambers are connected with check valves that provide for flow only in a specified direction. By appropriately positioning the check valves, a pump can be used to circulate the flowable negative electrode material in a particular flow pattern.

In some embodiments, a diaphragm pump is used within a particular chamber with at least two check valves, with one oriented to provide flow out from the chamber and a second oriented to provide flow into the chamber. During the pumping cycle, a diaphragm extends into the chamber to reduce the effective volume and thereby causing flow out from the corresponding check valve. When the diaphragm returns to its original position, the release of pressure results in flow into the chamber through the other corresponding check valve. In this way, the material within the chamber can be circulated into and out from the chamber. An adjacent chamber can include an expansion volume with a deformable, generally elastic, membrane to adjust for changes in internal volume during the pumping cycle.

The fuel cell can be configured with a plurality of one or more types of electrodes within the cell. A plurality of electrodes can be configured electrically in parallel and/or in series. For example, there can be sets of electrodes connected in parallel within a cell with a plurality of cells connected in series. In general, a separator is located between each negative electrode and a corresponding positive electrode. The separator is permeable to ions and is electrically insulating. The separator(s) inhibits or eliminates short circuiting between the negative and positive electrodes while providing for the maintenance of approximate electrical neutrality across the cell during operation, both cell discharge and fuel regeneration. Furthermore, a current collector can be associated with each electrode to reduce electrical impedance in the cell.

Depending on the particular application, it may be desirable to have fuel cells with large or small dimensions to provide appropriate capacities. In some embodiments, it is desirable to have portable fuel cells. The self-contained fuel cells can serve as suitable alternatives to secondary batteries in portable and nonportable applications. For some portable applications, it may be desirable to have a total volume no more than about 1 liter, in other embodiments, a total volume no more than about 250 cubic centimeters (cm³), in further embodiments from about 0.000001 cm³ to about 100 cm³, and in some embodiments from about 1 cm³ to about 25 cm³. A person of ordinary skill in the art will recognize that additional ranges of volumes within these explicit ranges are contemplated and are within the present disclosure.

The active layer(s) of the negative electrode(s) generally comprise a binder that supports catalyst particles and/or electrically conductive particles in a porous matrix. The backing layer is generally formed from a hydrophobic polymer, which may contain particles, in the form of a gas permeable membrane. A backing layer generally is laminated to the active layer to form a monolithic structure that resists de-lamination under moderate pressures.

The positive electrode used for reducing oxygen can be constructed differently from the electrode used for the generation of molecular oxygen. By using separate structures, the lifetime of the electrodes can be significantly prolonged relative to structures in which the same electrode is used for both reactions since the reaction conditions are different. Specifically, the electrode in which molecular oxygen is generated operates at a higher voltage in order to generate molecular oxygen (O₂) in an alkaline aqueous environment. In particular, amorphous carbon can be oxidized, and therefore degenerated, at the higher voltages at which molecular oxygen is generated at reasonable rates. However, amorphous carbon or carbon black is commonly used as electrically conductive particles in batteries and fuel cells. In place of the amorphous carbon, metal powders, such as elemental metal powders, powders of conducting metal compounds and/or graphite can be used to supply the desired amount of electrical conductivity. Some higher impedance can be tolerated during fuel regeneration than is desirable during discharge of the fuel cell.

In the positive electrode used to reduce molecular oxygen, hydroxide (OH⁻) ions are formed in the electrode. The formation of hydroxide ions can result in swelling of the electrode due to osmotic pressure resulting from a difference in ionic strength within the electrode and in the surrounding electrolyte. The swelling over time can distort the electrode structure which can lead to further swelling and loss of performance. To reduce or eliminate the swelling, an ion conducting polymer can be placed within the pores of the active layer. The ion conducting polymer can conduct the hydroxide ions or corresponding hydrogen/hydronium (H⁺/H₃O⁺) ions to generate the requisite ion flow. Suitable ion conducting polymers include, for example, Nafion® a perfluoronated sulfonoic acid polymer and other fluoronated polymers, as described below.

The negative electrode can comprise a paste. The viscosity of the paste can be controlled to improve handling and to prevent rapid flow of the material in the unlikely event of a breach of the fuel cell case while providing the desired amount of flow within the cell. The paste generally comprises particles of the electro-active material/fuel, electrically conductive particles and viscosity modifiers. After discharge of the fuel cell has taken place, the negative electrode generally also comprises oxidized forms of the fuel.

Each electrode can further comprise a current collector. The current collector associated with the positive electrodes generally is gas and/or ion permeable, such as a metal mesh. The current collector associated with the negative electrode may or may not be porous. In particular, for embodiments in which the fuel and fuel oxidation products are circulated, it may be desirable to use a fixed non-porous current collector for association with the negative electrode. In embodiments with a fixed negative electrode, a porous current collector may be desirable to provide for ionic flow. The current collectors generally lead to corresponding electrical contacts outside of the fuel cell case.

Appropriate separate contacts can be used for the positive electrode used for reduction of oxygen and the positive electrode for the evolution of oxygen such that their functions remain separate.

In general, the fuel cell is located within a case. Appropriate portions of each gas permeable positive electrode have regions exposed to the ambient atmosphere for air exchange or to an alternative oxygen source. By using air as the oxygen source, no additional storage container is needed for the storage of oxygen either during discharge or recharging of the fuel. However, a storage container for oxygen with fluid communication with both positive electrodes can be used. While providing for appropriate oxygen exchange, the case should provide mechanical stability to the fuel cell, maintain the positive and negative electrodes in close contact to reduce the internal electrical impedance and inhibit or prevent leakage of electrolyte. Once all the components are appropriately positioned within the case, the case is generally sealed to form a self-contained fuel cell. The case can be formed as resealable structure such that maintenance can be performed on the components such that the fuel cell can be used long term beyond the lifetime of some of the components.

In general, the fuel cells described herein are useful for applications in which the fuel cell can have a volume sufficient to store all of the fuel desired between regeneration of the fuel cell. In some embodiments, the fuel cells are small enough to replace corresponding secondary batteries. To regenerate the fuel cells, the fuel cell can be connected to line voltage through an appropriate adaptor, which generally converts the alternating current to a direct current and changes to voltage to an appropriate value to form the fuel, such as zinc, from the oxidized fuel, such as zincate and/or zinc oxide. Specifically, the external potential drives the reversal of the reactions in equations (1), (2) and possibly (3).

In some embodiments of a fuel cell, a metal fuel cell system is provided that is characterized in that it has one, or any suitable combination of two or more, of the following properties: the system optionally can be configured to not utilize or produce significant quantities of flammable fuel or product, respectively; the system can provide primary and/or auxiliary/backup power to the one or more loads for an amount of time limited only by the amount of fuel present (e.g., in the range(s) from about 0.01 hours to about 10,000 hours or more, and in the range(s) from about 0.5 hours to about 650 hours, or more); the system optionally can be configured to have an energy density in the range(s) from about 35 Watt-hours per kilogram of combined fuel and electrolyte (reaction medium) added to about 400 Watt-hours per kilogram of combined fuel and electrolyte added; the system optionally can further comprise an energy requirement and can be configured such that the combined volume of fuel and electrolyte added to the system is in the range(s) from about 0.0028 L per Watt-hour of the system's energy requirement to about 0.025 L per Watt-hour of the system's energy requirement, and this energy requirement can be calculated in view of, among other factors, the energy requirement(s) of the one or more load(s) comprising the system (In one embodiment, the energy requirement of the system can be in the range(s) from 0.05 Watt-hours to about 500 Watt-hours, whereas in another embodiment, the energy requirement of the system can be in the range(s) from 0.5 Watt-hours to about 5000 Watt-hours; in yet another embodiment, the energy requirement can range from 5×10⁻¹² Watt-hours to 50,000 Watt-hours).

Fuel cells are a particularly attractive power supply because they can be efficient and environmentally safe. Metal/air fuel cells can be used for both stationary and mobile applications, such as cell phones and laptop computers. Fuel cells offer advantages over internal combustion engines, such as zero emissions, lower maintenance costs, and higher specific energies. Higher specific energies can result in weight reductions. In addition, fuel cells can give vehicle designers additional flexibility to distribute weight for optimizing vehicle dynamics.

Fuel Cell Structure

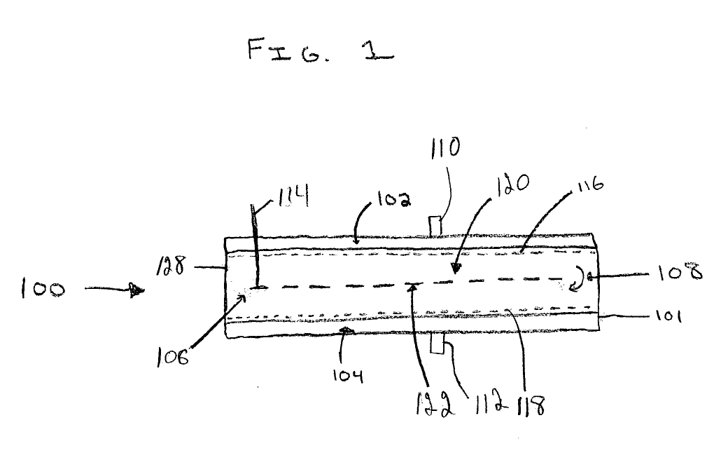

Referring to FIG. 1, the fuel cell 100 comprises a case 101, a first gas diffusion electrode 102 suitable for the reduction of molecular oxygen, a second gas diffusion electrode 104 suitable for the evolution of molecular oxygen, a negative electrode 106 and a pump 108. Case 101 can be sealed to isolate electrodes 102, 104, 106 within a chamber in the interior of case 101. At least a portion of case 101 can be composed of any gas permeable material suitable for use in fuel cell applications including, for example, porous metal, porous polymer and combinations thereof. Suitable polymers include, for example, polycarbonate, polyethylene, polyethylene, poly(tetrafluoroethylene), polypropylene, polystyrene and blends and mixtures thereof. In general, the choice of material used for the outer walls of the case 101 will be determined by the intended application of a particular embodiment. In some embodiments, case 101 can optionally be housed in a protective housing to further protect case 101 while providing appropriate air flow.

In some embodiments, the first gas diffusion electrode 102 can be aligned in a comparable orientation, such as along the same plane, as the second gas diffusion electrode 104. However, as shown in FIG. 1, first gas diffusion electrode 102 and second gas diffusion electrodes 104 are arranged to have surfaces facing each other. While some orientations can be convenient for particular applications, any one or more of a variety of electrode orientations can be suitable for forming the fuel cell. Fuel cell 100 can comprise more than one gas diffusion electrode suitable for reducing molecular oxygen and/or more than one electrode suitable for generating molecular oxygen, which can be arranged appropriately based on the discussion herein. Similarly, if the fuel cell comprises a pump, the pump can be within the same chamber as one or more of the electrodes or in a separate chamber.

Gas diffusion electrodes 102, 104 generally comprise an active or catalytic layer, a backing layer and a separator in which the active layer is located between the backing layer and the separator. The separator is generally adjacent the negative electrode while the backing layer generally is oriented toward the case to provide air flow. The backing layer generally is hydrophobic to prevent the flow liquid electrolyte from the cell but porous to gas to provide for air exchange. In some embodiments, first gas diffusion electrode 102 and second gas diffusion electrodes 104 each can further comprise a current collector. As discussed below, the current collectors can be composed of any electrically conductive material suitable for use in fuel cell electrodes. Examples of suitable material for the current collectors include metal meshes, metal screens and the like. As shown in FIG. 1, first gas diffusion electrode 102 and second gas diffusion electrode 104 can be electrically coupled, respectively, to electrode terminals 110, 112, generally through current collectors. Electrode terminals 110, 112 provide for selective electrical attachment to gas diffusion electrode 102 for discharge and gas diffusion electrode 104 for regeneration of fuel. Similarly, electrode terminal 114 provides for electrical connection with negative electrode 106. Referring to FIG. 1, the first gas diffusion electrode 102 and second gas diffusion electrode 104 respectively include separators 116, 118 to separate gas diffusion electrodes 102, 104 from the negative electrode 106. Separators 116, 118 can be composed of suitable ion permeable electrically insulting materials, which are described further below.

Gas diffusion electrode 102 generally comprises materials suitable for the reduction of molecular oxygen. In particular, the catalyst in the active layer of gas diffusion electrode 102 can be appropriately selected as described further below. In some embodiments, gas diffusion electrode 102 can further comprise an ion diffusion polymer, as described further below, to reduce or eliminate swelling of the electrode due to osmotic pressure. Gas diffusion electrode 104 generally comprises materials suitable for the evolution of molecular oxygen. In particular, the catalyst within gas diffusion electrode 104 can be selected appropriately, as described further below. Furthermore, gas diffusion electrode 104 generally does not include electrically conductive graphitic carbon, since graphite can react at the electrical potentials generally used to generate molecular oxygen. The compositions for the gas diffusion electrodes are described further below.

In some embodiments, negative electrode 106 comprises a flowable material or paste 120 and a current collector 122. In these embodiments, negative electrode paste 120 can optionally be circulated within case 101 to contact both the first and second gas diffusion electrodes 102, 104. In some embodiments, paste 120 can comprises an aqueous solution of Zn particles, oxidized zinc, such as zincate and/or ZnO, and an electrolyte. In some embodiments, the electrolyte is KOH, however, other electrolytes can be used in paste 120. Additionally, the paste 120 can comprise additives such as viscosity modifiers and electrically conductive particles. Suitable viscosity modifiers include, for example Carbopol® (Noveon Inc.). Furthermore, paste 120 generally also includes electrically conductive particles, such as conductive carbon, non-electrocative metal powders, such as nickel and/or chromium, and/or electrically conductive metal compounds, such as Ebonex® ceramics (titanium oxides, Fosroc International, Ltd.). Paste 120 can further comprise other additives including, for example, corrosion inhibitors, such as, indium, bismuth and/or lead.

In some embodiments, the paste 120 comprises from about 5 weight percent to about 85 weight percent Zn particles and in other embodiments from about 30 weight percent to about 80 weight percent. In further embodiments the paste comprises from about 70 weight percent to about 76 weight percent Zn particles. The zinc particles are combined with electrolyte within the negative electrode paste. Viscosity modifiers and/or corrosion inhibitors generally are included within the electrolyte at concentrations less than about 5 weight percent, and in other embodiments less than about 1 weight percent.

As shown in FIG. 1, negative electrode current collector 122 is located between gas diffusion electrodes 102, 104. Negative electrode current collector 122 can be composed of an electrically conducting material, such as a metal foil or metal mesh. In general, the current collector may be positioned to avoid interfering with any desired flow of positive electrode paste 120. In one embodiment, negative electrode current collector 122 does not extend to the sides 128 of case 101, although current collector 122 then generally would be in contact with the top and/or bottom of case 101 to support the current collector in place. In this embodiment, passages, or gaps, are created around the sides 128 of positive electrode current collector 122. These passages allow paste 120 to be optionally circulated around positive current collector 106 to pass by first gas diffusion electrode 102 and second gas diffusion electrodes 104.

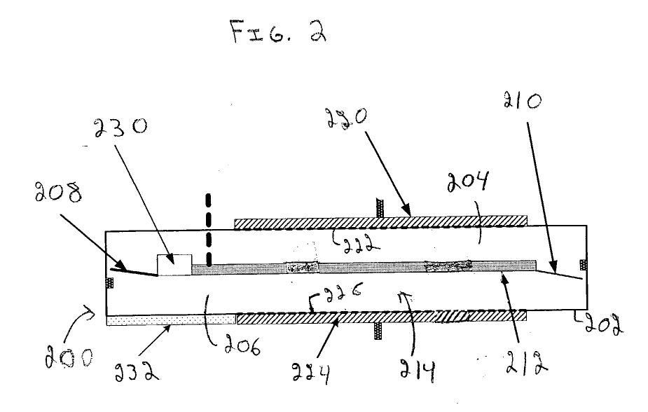

In some embodiments, fuel cell 100 comprises a pump 108. The pump can be within case 101 or exterior to case 101. As noted above, the term pump is used in its broad sense to include any device that moves fluids. Thus, the pump can physically manipulate case 101 from the exterior to result in movement of the negative electrode paste. In some embodiments, pump 108 is operably positioned within the case 101 to circulate negative electrode paste 120. Suitable pumps include, for example, mechanical pumps, peristaltic pumps, compression membranes, expansion chambers and the like. A fuel cell is shown in FIG. 2 having an expansion chamber to pump the electrode paste.

Referring to FIG. 2., fuel cell 200 comprises a case 202, a first chamber 204, a second chamber 206 and check valves 208, 210 connecting first chamber 204 from second chamber 206. A negative electrode current collector 212 separates first chamber 204 from second chamber 206. Generally, a negative electrode paste 214 is located within first chamber 204 and second chamber 206. Suitable negative electrode paste compositions are described above. A first gas diffusion electrode 220 suitable for reducing molecular oxygen contacts first chamber 204, and separator 222 separates gas diffusion electrode 220 from negative electrode paste 214 to prevent short circuiting of the cell. Similarly, a second gas diffusion electrode 224 suitable for generating molecular oxygen contacts second chamber 206, and separator 226 separates gas diffusion electrode 224 from negative electrode paste 214 to prevent short circuiting. Suitable separator materials are described below. Case 202 can have similar properties to case 101 described above. Fuel cell 200 can comprise additional gas diffusion electrodes, as desired, and the positioning of the gas diffusion electrodes can be altered as desired, although some positions of the gas diffusion electrodes may lead to lower electrical impedance, which can be evaluated by a person of ordinary skill in the art.

In this embodiment, negative electrode paste 214 can be circulated between first chamber 204 and second chamber 206 through check valves 208, 210. Check valves 208, 210 restrict flow in a particular direction due to the action of a pump, described below. In particular, check valve 208 permits flow from first chamber 204 to second chamber 206 but prevents or significantly inhibits flow from second chamber 206 to first chamber 204. Similarly, check valve 210 permits flow from second chamber 206 to first chamber 204 but prevents or significantly inhibits flow from first chamber 204 to second chamber 206. Check valves 208, 210 can have any reasonable construction, such as hinged flaps of durable material or the like. One of ordinary skill in the art will recognize that no particular flow direction of the paste 214 is required, and thus the flap valves shown in FIG. 2 could be reversed to allow the paste 214 to flow in the opposite direction.

Referring to FIG. 2, a pump can be incorporated into the structure of case 202 to provide for the circulation of negative electrode paste 214. In one embodiment, the pump comprises a pump expansion chamber 230 and a passive expansion chamber 232. The pump expansion chamber 230 can optionally expand, which can force paste 214 to move through check valve 208 from first chamber 204 into second chamber 206. The additional volume of paste in second chamber 206 is adsorbed into passive expansion chamber 232. Similarly, pump expansion chamber 230 can collapse to crate a drop in pressure in first chamber 204. This pressure drop in first chamber 204 results in the flow of paste 214 from second chamber 206 through check valve 210 into first chamber 204. A person of ordinary skill in the art will recognize that other pumps and mechanisms can be used to circulate paste 214 between chambers 204, 206. Passive expansion chamber 232 can be generally composed of an elastic or deformable material, which provides a means to adjust for internal changes in volume during the pumping cycles.

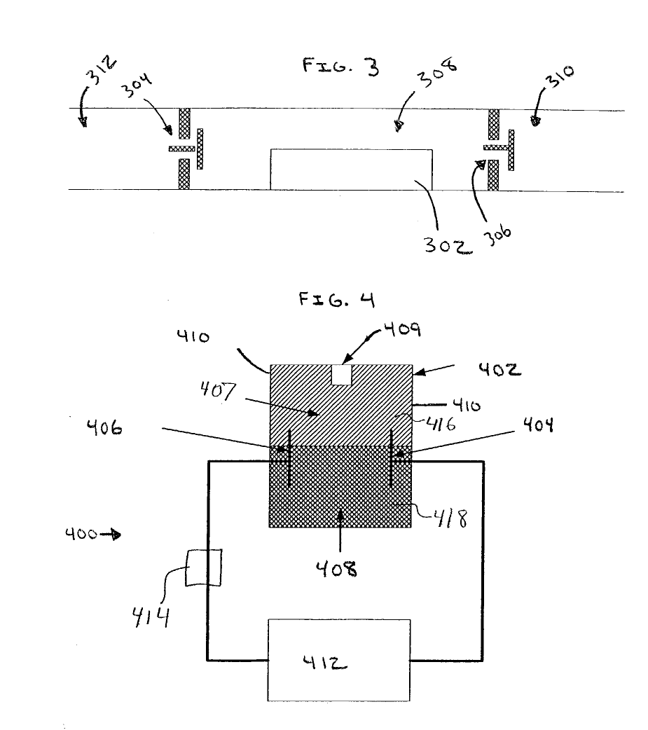

Examples of pumps and expansion chambers suitable for use in the present invention are shown in FIGS. 3-6. Referring to FIG. 3, an embodiment of an electrochemically based pump for fluids is disclosed. As shown in FIG. 3, the driving element for the pump is an expansion chamber 302. When the expansion chamber 302 expands, fluid is displaced and valve 304 closes in response to fluid pressures. This results in the displacement of liquid or paste through valve 306. As expansion chamber 302 contracts, valve 306 closes due to the pressure differential between the second chamber 308 and the third chamber 310. As a result, fluid or paste is drawn into second chamber 308 because of the lower pressure in second chamber 308 with respect to first chamber 312.

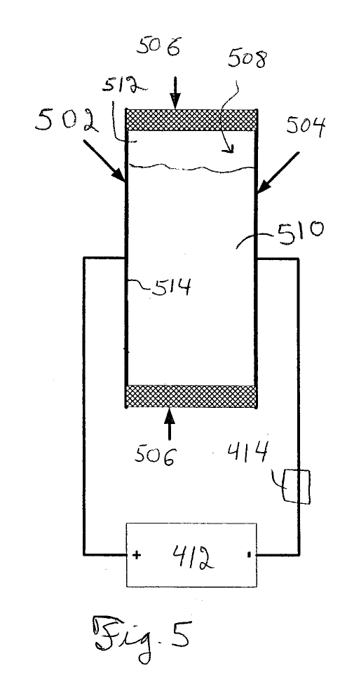

Referring to FIG. 4-6, several embodiments of electrochemically driven expansion chambers for a pump are disclosed. The pumps/expansion chambers in FIGS. 4-6 can be made extremely resilient to function over at least 100,000s of cycles of the expansion and contraction. As shown in FIG. 4, one embodiment of an expansion chamber 400 comprises an expandable container 402 with two electrodes 404, 406 within the interior 407 of expandable container 402. Expandable container 402 can be composed of an elastomer or the like. Interior 407 can contain an aqueous solution 408 comprising water and an electrolyte, for example, NaCl, and a hydrogen and oxygen recombination catalyst 409, which can be positioned at a location at the top of interior 407. Power supply 412 provides the voltage to electrodes 404, 406 under the control of controller 414 that switches the current on and off appropriately. The voltage generally is at least about 1.23 Volts such that hydrogen and oxygen are generated by the applied voltage. Controller 414 can be integrated with the controller for the fuel cell. Due to the generation of hydrogen and oxygen, interior 407 can comprise gas 416 as well as liquid solution 418.

During operation, an electric current is passed between the electrodes at a voltage sufficient to generate hydrogen and oxygen. The generation of hydrogen and oxygen increases the volume of the chamber, which expands elastomeric walls 410 of chamber 400. In general, the rate and amount of expansion will be determined by the electrolysis current. As the gases are formed, the gases can contact recombination catalysts 409 and condense to form liquid water. If the recombination rate exceeds the electrolysis rate, the expansion chamber will contract in volume, while if the gas generation rate is greater than the recombination rate, the chamber increases in volume.

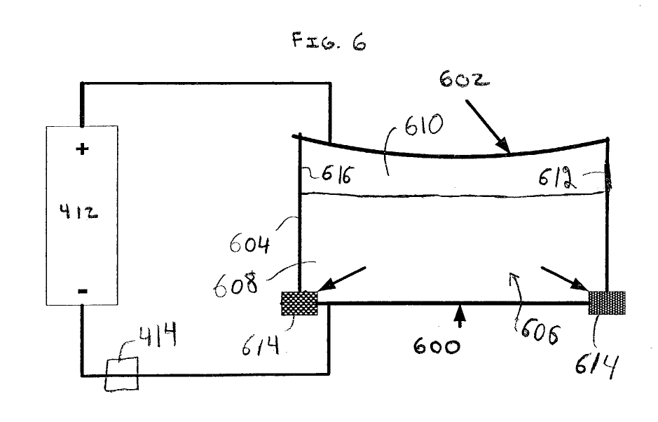

FIG. 5 shows another embodiment of the expansion chamber where the expansion chamber comprises two metal plates 502, 504 separated by a side wall 506 comprising an elastomer. Metal plates 502, 504 and side walls 506 form an inner volume 508 in which an aqueous solution 510 with water and an electrolyte and gas 512 can be located. The inner surface of top electrode 502 or a portion thereof has a coating of catalyst 514, such as platinum or palladium, for the reaction of hydrogen and oxygen. In this embodiment, when voltage from power source 412 is applied to metal plates 502, hydrogen gas and oxygen gas are generated which rise to the top of inner volume 508 adjacent top electrode 502. When the current is sufficient to generate gas faster than it reacts by contact with the catalyst, the elastomeric walls expand to increase the size of volume 508 due to the increase in pressure. When gas is generated slower than it is reacted at the catalyst, the pressure decreases in volume 508 and elastomeric walls 506 contract to reduce the size of volume 508.

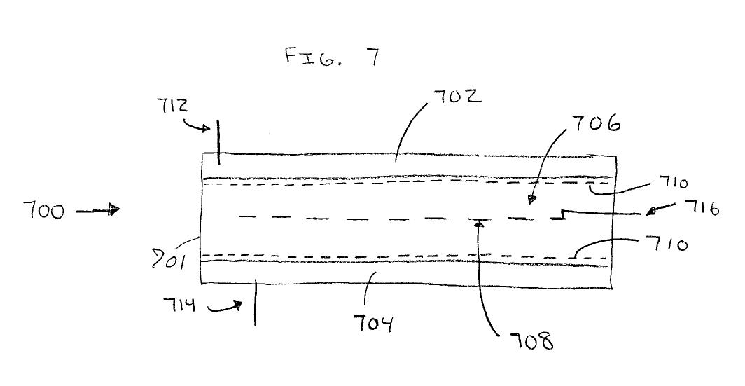

Another embodiment is shown in FIG. 6. In this embodiment, one electrode 600 can be flat while the other electrode 602 is dished such that it has two configurations curving outward or curving inward. Side walls 604 are sealed to electrodes 600, 602 to form a volume 606 that again contains an aqueous solution 608 with water and an electrolyte and a gas 610, at least when current is flowing. Side walls 604 or a portion thereof can have a coating of catalyst 612 to react hydrogen and oxygen gas. Insulating element(s) 614 can electrically isolate side walls 604 from electrode 600. When current is flowing to create gas faster than the hydrogen and oxygen recombine at the catalyst, the pressure in volume 606 increases and electrode 602 dishes outward to increase the size of volume 606. Similarly, when the current is turned off or otherwise insufficient to generate as much gas as is reacting to form water at the cataylst, the pressue in volume 606 drops, and electrode 602 dishes inward at sufficiently low pressure. Contact with the outer surface of electrode 602 experiences a pumping action due to volume changes effectuated by the dishing alternatively inward and outward of electrode 602.

Referring to FIG. 7, another embodiment of a self-contained fuel cell is shown. In this embodiment, fuel cell 700 comprises a case 701, a first gas diffusion electrode 702 suitable for the reduction of molecular oxygen, a second gas diffusion electrode 704 suitable for the generation of molecular oxygen, a positive electrode paste 706 and a positive electrode current collector 708. In some embodiments, positive electrode current collector 708 is located in between first gas diffusion electrode 702 and second gas diffusion electrode 704, as shown in FIG. 7. In this embodiment, fuel cell 700 does not contain a pump to circulate the positive electrode paste 706, and as a result the paste 706 is consumed in a gradient fashion across the fuel cell.

The first and second gas diffusion electrodes 702, 704 can be the same as the electrodes described above. In particular, gas diffusion electrodes 702, 704 can further comprise current collectors, and separators 710 can be attached to the gas diffusion electrodes 702, 704, respectively, to prevent short circuiting of the cell. Suitable current collectors and separators are described below. Electrode terminals 712, 714 can be electrically coupled to the first and second gas diffusion electrodes 702, 704, generally by way of a current collector. Electrode terminal 716 can be electrically coupled to the positive electrode current collector 708. One of ordinary skill in the art will recognize that other arrangements of the fuel cell components are within the scope of the disclosure.

Gas Diffusion Electrode Compositions

The gas diffusion electrodes of the present invention generally comprise an active layer attached to a backing layer. The active layer comprises catalyst particles for catalyzing the electrode reactions. Generally, the electrochemical reactions take place in the active layer, and the backing layer permits reactants, generally gases, to permeate to the active layer. The backing layer can also prevent the electrolyte, or other fluid, from diffusing out of the active layer through the backing layer. As will be discussed below, in some embodiments the active layer of the electrode suitable for the reduction of molecular oxygen has a different composition than the active layer of the electrode suitable for the evolution of molecular oxygen.

The active layer of the gas diffusion electrodes generally can comprise a matrix polymer, a catalyst, and in some embodiments electrically conductive particles. Also, in some embodiments, the active layer can further comprise an ion-conducting polymer instilled within the pores of the matrix polymer. In general, the matrix polymer can be any polymer suitable for forming a porous particle-filled material. The matrix polymer can be a homopolymer, copolymer, block copolymer or polymer blend or mixture. Suitable matrix polymers include, but are not limited to, poly(ethylene), poly(tetrafluoroethylene), poly(propylene) and poly(vinylidenefluoirde). Other suitable matrix polymers include styrene block copolymers including, for example, styrene- isoprene-styrene, styrene-ethylene-butylene-styrene and styrene-butadiene-styrene. Suitable styrene block copolymers are sold under the trade name KRATON®.

In some embodiments, the active layer of the gas diffusion electrodes comprises an ion conducting polymer instilled within the pores of the matrix polymer. Any polymeric material that can act as an ion conducting membrane can potentially be used. Suitable materials for the ion conducting polymer include sulfonated, phosphonated or carboxylated ion conducting aromatic polymers. Preferred aromatic polymers include, but are not limited to, polysulfones, polyimides, polyphenylene oxides, polyphenylene sulfoxides, polyphenylene sulfides, polyphenylene sulfide sulfones, polyparaphenylenes, polyphenylquioxalines, polyarylketones and polyetherketones. Other suitable ion conducting polymers are perfluorinated sulfonic acid membranes. One suitable perfluorinated sulfonic acid membrane is sold under the trade name Nafion® by E.I. Dupont de Nemours and Co. Further discussion active layers with ion conducting polymers can be found in copending U.S. patent application Ser. No. 10/364,768 to Smedley, entitled “Fuel Cell Electrode Assembly,” which is hereby incorporated by reference.

The electrically conductive particles can comprise carbon conductors, such as, for example, carbon black, other carbon particles, metal particles, conductive metal compounds, or combinations thereof. Suitable carbon blacks, i.e., amorphous carbon, generally include, for example, actylene blacks, furnace blacks, thermal blacks, and modified carbon blacks. In some embodiments, the electrically conductive particles used in the gas diffusion electrode suitable for the reduction of molecular oxygen are different than the conductive particles used in the electrode suitable for evolution of molecular oxygen. In general, amorphous carbon particles are not included as the conductive particles for the active layer of the electrode suitable for the evolution of molecular oxygen, since amorphous carbon may react under conditions used for oxygen evolution. Suitable conductive particles that can be used in the active layer of the electrode suitable for evolution of molecular oxygen include, for example, graphitic carbon, metal particles, conductive metal compounds or combinations thereof.

While the electrically conductive particles may also function as catalysts in the gas diffusion electrodes, generally a specific catalyst material is added to the active electrode layer. In general, suitable catalysts include, for example, metal particles, metal compositions and combinations thereof. Suitable metals broadly cover all recognized metal elements of the periodic table and alloys thereof. Exemplary metals include, without limitation, Fe, Co, Ag, Ru, Mn, Zn, Mo, Cr, Cu, V, Ni, Rh, Pt and combinations thereof. Suitable metal compositions may include, for example, permanganates, metal oxides, decomposition products of metal heterocycles, cobalt complexes, perovskites, napthenates, and combinations thereof.

In some embodiments, the catalyst used in the gas diffusion electrode suitable for the reduction of molecular oxygen is different that the catalyst used in the gas diffusion electrode suitable for the evolution of molecular oxygen. Suitable catalysts for the reduction of molecular oxygen include, for example, elemental metals and their alloys, transition metal macrocycles, metal oxides and perovskites. Some specific metals include, for example, Ag, Pt, Pd, Ru and alloys and combinations thereof. In some embodiments, the metal particles are coated onto carbon particles. The carbon black-metal-nitrogen containing catalysts are described in copending and commonly assigned U.S. patent application Ser. No. 09/973,490 to Lefebvre, entitled “Methods of Producing Oxygen Reduction Catalyst,” incorporated herein by reference. Suitable metal oxides include, but are not limited to, MnO₂ and Mn₂O₃. Suitable catalysts for the evolution of molecular oxygen generally include, for example, elemental metals and their alloys, metal oxides, spinels, perovskites and combinations thereof. Some specific catalysts include, for example, NiO and perovskite, such as La_{0.5}Sr_{0.5}CoO₃.

In general, the backing layers comprise polymers that are hydrophilic, such as poly(tetrafluoroethylene), poly(ethylene), poly(propylene), poly(vinylidenefluoride) or mixtures thereof. In some embodiments, the backing layer can comprise particles, such as electrically conductive particles, within a porous water resistant composite.

In some embodiments, the gas diffusion electrodes further comprise a current collector. A current collector is a highly electrically conductive structure that is combined with the active layer and/or backing layer to reduce the overall electrical resistance of the electrode assembly. Suitable current collectors can be formed from elemental metals or alloys thereof, although they can, in principle be formed from other electrically conductive materials. While in some embodiments a metal foil or the like can be used as a current collector, for gas diffusion electrodes, it is generally desirable to have a current collector that is permeable to the gaseous reactants such that the gas can flow through the electrode. Thus, in some embodiments, the current collector comprises a metal mesh, screen, wool, or the like. The current collector generally extends over a majority of the face of the electrode composition and may comprise a portion that extends beyond the electrode composition, for example, a tab that can be used to make an electrical connection to the current collector.

In general, an electrode assembly can be formed by combining the electrode composition, which comprises the active layer and the backing layer, with a current collector and/or additional electrode layers. The active layer and the backing layer can be formed separately, for example, by extrusion, calendering, and/or molding, or simultaneously, for example, by coextrusion. If the active layer and the backing layer are separately formed, the backing layer and the active layer can be laminated together, for example, by calendering and/or by an adhesive. Additionally, in embodiments that comprise an ion conducting polymer, the ion conducting polymer can be added to the active layer during formation of the active layer structure or after the formation of the active layer structure. The electrode composition can be shaped and processed, for example, by compression molding, extruding, calendaring and high shear mixing.

The electrode composition typically is formed into a structure with a generally planar aspect with a thickness that is significantly smaller than the dimensions across the face of the planar structure. Compositions, assembly and processing of gas diffusion electrodes are further discussed in copending U.S. patent application Ser. No. 10/364,768 to Smedley, entitled “Fuel Cell Electrode Assembly,” which is hereby incorporated by reference, and in copending U.S. patent application Ser. No. 10/288,392 to Munoz et al., entitled “Gas Diffusion Electrodes,” incorporated herein by reference.

Fuel Cell Construction

The fuel cells of the present invention generally comprise at least one gas diffusion electrode suitable for the reduction of molecular oxygen and at least one gas diffusion electrode suitable for the generation of molecular oxygen. In some embodiments, the fuel cells further comprise a positive electrode paste that can be optionally circulated inside the fuel cell. In embodiments where the paste is circulated, one or more pumps are operably positioned within the fuel cell to circulate the paste. Additionally, in embodiments where the paste is circulated, valves can optionally be placed inside the fuel cell to permit flow of the paste in a single direction.

In general, the gas diffusion electrodes are assembled prior to placement within the fuel cell case. In some embodiments, the fuel cell can be assembled by placing the component parts of the fuel cell inside the case and then filling a chamber within the case with an electrode paste. Once the paste and the fuel cell components are inside the chamber, the chamber can be sealed. The chamber may be sealed by any method that will not inhibit the function of the fuel cell. Suitable methods for sealing the fuel cell include adhesives, sintering, laminating, heat press, sonic welding, mechanical fasteners and the like. The fuel cell generally is sealed to reduce or eliminate loss of electrolyte through evaporation or leaking. The fuel cell case can be permanently or reversable sealed. If the case is permanently sealed, generally the case must be damaged to reopen the case, for example, to recycle components prior to disposal. If the case is reopenable, the fuel cell may be reconditioned to prolong its operating life, for example, by replacement or addition of electrolyte and or fuel.

In some embodiments, the gas diffusion electrodes may form at least part of the outer wall of the case. In some embodiments, the gas diffusion electrodes can be attached to the case by any suitable means including, for example, mechanical fasteners, adhesives or lamination. In some embodiments, the negative current collector is operably connected to the case to prevent the negative current collector from moving during operation of the fuel cell. The negative current collector can be attached to the case by suitable mechanical fasteners including, for example, adhesives, sonic welding, and/or fasteners.

In other embodiments, the outer wall of the case can be provided with a port to provide access into the fuel cell without a tool. The port allows fluid, for example, paste, to be transported into and out of the chamber. For example, the port can be opened/closed by disengaging/engaging a plastic clasp or the like. In this embodiment, the fuel cell can be constructed by placing the components of the fuel cell inside the chamber and subsequently sealing the chamber. Once the chamber is sealed, the electrode paste can be introduced into the chamber though the port. Additionally or alternatively, the port can be used to replace the paste within the fuel cell, or to add fuel, electrolyte or other components to the existing paste in the fuel cell.

Fuel Cell Operation

During cell discharge, a circuit is closed to connect electrically the electrode terminal for the positive gas diffusion electrode suitable for the reduction of molecular oxygen and the electrode terminal for the negative electrode current collector. Then, molecular oxygen can be reduced, while fuel stored in the electrode paste is consumed. During the fuel regeneration operation, a circuit is closed to apply an external potential to the positive gas diffusion electrode terminal for the electrode suitable for the generation of molecular oxygen and the electrode terminal for the negative electrode current collector. The external potential drives the evolution of molecular oxygen, while an oxidized form of the fuel is reduced to regenerate the fuel, such as zinc.

In some embodiments in which the fuel cell comprises a pump, the pump can circulate negative electrode paste during cell discharge, during fuel regeneration, both during cell discharge and fuel regeneration and/or during other periods of time when neither cell discharge is occurring nor fuel is being regenerated. In some embodiments, during the cell discharge phase, the pump can move, or circulate, components of the negative electrode, such as the paste. Movement of the paste tends to maintain a more uniform concentration of fuel and oxidized forms of the fuel through the paste such that a portion of the paste does not get substantially depleted of fuel while other portions of the paste have the fuel in substantially unoxidized form. In alternative embodiments, one portion of the fuel can be substantially consumed adjacent the gas diffusion electrode, then the pump is operated to move the negative electrode paste to replace the consumed paste with another section of electrode paste with fuel that is substantially unconsumed. In these embodiments, the pump is used to process sequential portions of the electrode paste rather than more uniformly consuming the fuel. The operation of the pump can be selected to achieve the particular desired mode of operation based on the particular rate of fuel consumption, fuel volume and other fuel cell parameters.

In embodiments where the pump circulates a negative electrode paste, the pumping can be continuous or intermittent. When the pump is operating in an intermittent fashion, the pump can circulate the paste for a specified period of time, which can then be followed by a specified period of time when the pump is inactive. The intermittent operation can be involve periodic or non-periodic period of pumping and non-pumping times. The length of the specified period of time, or time interval, in the periodic operation of the pump can be determined by a particular application.

In some embodiments, the fuel cell does not contain a pump. While the operation of these embodiments may depend on the particular impedance within the cell, fuel such as zinc generally is consumed first adjacent the separator at the positive electrode at which oxygen is reduced. Thus, as the fuel is consumed, a gradient is established in the fuel with the fuel oxidation product building up toward the separator and propagating outward through the negative electrode material. During fuel regeneration, if the positive electrode for oxygen evolution is facing the positive electrode for oxygen reduction, the fuel regeneration generally propagates in the opposite direction as the fuel consumption with the oxidation product closer to the separator adjacent the positive electrode for oxygen evolution regenerating first.

In some modes of operation, the fuel located in the paste may be substantially exhausted before the regeneration phase is started. In other modes of operation, the regeneration phase can be started before all of the fuel in the paste is consumed. In further modes of operation the power/regeneration phases can be alternated over specific time periods. One of ordinary skilled in the art will recognize that numerous variations in paste circulation rate and power/regeneration phase alternation are within the scope of the disclosure.

The embodiments above are intended to be illustrative and not limiting. Additional embodiments are within the claims. Although the present invention has been described with reference to particular embodiments, workers skilled in the art will recognize that changes may be made in form and detail without departing from the spirit and scope of the invention.

What we claim is:

1. A fuel cell comprising a pump, a first chamber, an electrode suitable for reduction of molecular oxygen accessible to the first chamber, and an electrode suitable for evolution of molecular oxygen, and wherein the pump is configured to circulate flow of a fuel cell composition comprising a fuel within the chamber, wherein the fuel cell composition can be selectively coupled as a cell with the electrode suitable for reduction of molecular oxygen and the electrode suitable for evolution of molecular oxygen.

2. The fuel cell of claim 1 wherein the fuel cell composition comprises an elemental metal.

3. The fuel cell of claim 2 wherein the elemental metal comprises zinc, a zinc alloy or combinations thereof.

4. The fuel cell of claim 3 wherein the fuel cell composition comprises oxidized zinc.

5. The fuel cell of claim 1 wherein the fuel cell composition comprises an aqueous base.

6. The fuel cell of claim 1 wherein the pump comprises a deformable diaphragm and a switch to control the deformation of the diaphragm.

7. The fuel cell of claim 1 wherein the electrode suitable for oxygen reduction comprises an active layer comprising a catalyst and a backing layer oriented away from the first chamber through which gas can diffuse.

8. The fuel cell of claim 7 wherein the active layer further comprises an ion conducting polymer within a polymer matrix.

9. The fuel cell of claim 7 wherein the backing layer further comprises carbon particles.

10. The fuel cell of claim 1 wherein the electrode suitable for evolution of molecular oxygen comprises an active layer comprising a catalyst and a backing layer oriented away from the second chamber through which gas can diffuse.

11. The fuel cell of claim 10 wherein the active layer is substantially free of amorphous carbon particles.

12. The fuel cell of claim 10 wherein the active layer comprises an electrical conductor comprising graphitic carbon, powdered elemental metal or a conductive metal composition.

13. The fuel cell of claim 1 wherein the fuel cell composition further comprises a viscosity modifying agent.

14. The fuel cell of claim 13 wherein the viscosity modifying agent comprises a cellulose derivative.

15. The fuel cell of claim 1 having a self-contained volume less than about 1 liter.

16. The fuel cell of claim 1 comprising a second chamber wherein the electrode suitable for evolution of molecular oxygen is accessible from the interior of the second chamber.

17. The fuel cell of claim 16 comprising a first check valve and a second check valve wherein the first check valve is configured to inhibit flow from chamber 2 to chamber 1 and the second check valve is configured to inhibit flow from chamber 1 to chamber 2 and wherein the pump is configured to circulate flow of a fuel cell composition between chamber 1 and chamber 2 through check valve 1 and check valve 2.

18. The fuel cell of claim 16 further comprising a central current collector in contact with the first chamber and the second chamber.

19. The fuel cell of claim 18 wherein the central current collector comprises an elemental metal, a metal alloy or a combination thereof, and is a non-porous barrier between the first chamber and the second chamber.

20. The fuel cell of claim 16 wherein the pump comprises a deformable diaphragm and wherein the deformable diaphragm is within the first chamber and the second chamber comprises a passive expansion chamber.

21. The fuel cell of claim 16 wherein the pump comprises a deformable diaphragm and wherein the deformable diaphragm is within the second chamber and the first chamber comprises a passive expansion chamber.

22. The fuel cell of claim 1 wherein a first separator is located between the electrode suitable for reduction of molecular oxygen and the interior of the first chamber and a second separator is located between the electrode suitable for evolution of molecular oxygen and the interior of the second chamber.

23. The fuel cell of claim 22 wherein the first separator and the second separator comprise a porous polymer.

24. A fuel cell comprising a first gas diffusion electrode suitable for reduction of molecular oxygen, a second gas diffusion electrode suitable for evolution of molecular oxygen, a negative electrode comprising a fuel, a first separator between the first gas diffusion electrode and the negative electrode and a second separator between the second gas diffusion electrode and the negative electrode, wherein the first electrode comprises a catalyst and wherein the second electrode comprises a catalyst and is substantially free of amorphous carbon.

25. The fuel cell of claim 24 further comprising a first chamber having an internal surface comprising in part by a surface of the first gas diffusion electrode, a second chamber having a surface comprising in part by a surface of the second gas diffusion electrode, a pump, a first check valve configured to inhibit flow from chamber 2 to chamber 1 and a second check valve configured to inhibit flow from chamber 1 to chamber 2, wherein the pump is configured to circulate flow between chamber 1 and chamber 2 through check valve 1 and check valve 2.

26. The fuel cell of claim 25 further comprising a central electrode wherein the first separator is between the central electrode and the first gas diffusion electrode and the second separator is between the central electrode and the second gas diffusion electrode.

27. The fuel cell of claim 26 wherein the central electrode comprises a current collector comprising an elemental metal, a metal alloy or combinations thereof.

28. The fuel cell of claim 26 wherein the central electrode comprises electrolyte.

29. The fuel cell of claim 28 wherein the electrolyte comprises an aqueous base.

30. The fuel cell of claim 26 wherein the central electrode comprises an oxidizable metal.

31. The fuel cell of claim 30 wherein the oxidizable metal comprises zinc, a zinc alloy, of combinations thereof.

32. The fuel cell of claim 30 wherein the central electrode further comprises oxidized zinc.

33. The fuel cell of claim 26 having a self-contained volume less than about 1 liter.

34. The fuel cell of claim 24 wherein the first electrode comprises amorphous carbon.

35. A self-contained fuel cell and fuel regeneration system comprising a first gas diffusion electrode suitable for reduction of molecular oxygen, a second gas diffusion electrode suitable for evolution of molecular oxygen, a negative electrode comprising a fuel, a first separator between the first gas diffusion electrode and the positive electrode and a second separator between the second gas diffusion electrode and the negative electrode, the self-contained system having a volume less than about 1 liter.

36. The self-contained fuel cell and fuel regeneration system of claim 35 wherein the fuel comprises zinc, zinc alloy or combinations thereof.

37. A portable power generation system comprising a negative electrode, a positive electrode, an electroactive fuel, electrolyte, and a pump, wherein the pump comprises an expansion chamber within a pump chamber and wherein the pump is configured to circulate electrolyte, the pump chamber comprising a first check valve that permits flow into the pump chamber and a second check valve that permits flow out from the pump chamber.

38. The power generation system of claim 37 wherein the pump chamber comprises zinc, zinc alloy or combinations thereof.

39. The power generation system of claim 37 wherein the pump comprises a control system to expand or contract the expansion chamber.

40. A method for generating power with a portable self-contained power source comprising a first chamber and a second chamber, the method comprising:
discharging the power source to convert a fuel into a reaction product in a first chamber, wherein the reaction product is deposited in a flowable electrolyte;
circulating the electrolyte between the first chamber and the second chamber; and
regenerating the fuel in the second chamber.

41. The method of claim 40 wherein the power source further comprises a pump configured to circulate the flowable electrolyte between the first chamber and the second chamber.

42. A method for generating power with a portable self-contained power source comprising a first gas diffusion electrode suitable for reduction of molecular oxygen, a second gas diffusion electrode suitable for evolution of molecular oxygen and a central electrode between the first gas diffusion electrode and the second gas diffusion electrode, the method comprising:
discharging the power source through an electrical contact connected to the first gas diffusion electrode and an electrical contact connected to the central electrode; and
regenerating the power source by applying an external potential to an electrical contact connected to the second gas diffusion electrode and an electrical contact connected to the central electrode.

43. The method of claim 42 wherein the central electrode comprises a porous current collector comprising metal.

44. The method of claim 42 wherein the central electrode comprises a flowable fuel, a first chamber having an inner surface accessible to a surface of the first gas diffusion electrode, a second chamber having an inner surface accessible to a surface of the second gas diffusion electrode and a pump configured to circulate the flowable fuel between the first chamber and the second chamber.
